(19) United States
(12) Patent Application Publication
(10) Pub. No.: US 2019/0227547 A1
(43) Pub. Date: Jul. 25, 2019

(54) DRIVE MODE SWITCH CONTROLLER, METHOD, AND PROGRAM

(71) Applicant: OMRON Corporation, Kyoto-shi, KYOTO (JP)

(72) Inventors: Hiroshi SUGAHARA, Kyoto-shi (JP); Hiroyuki MIYAURA, Kyoto-shi (JP); Michie UNO, Kyoto-shi (JP)

(73) Assignee: OMRON Corporation, Kyoto-shi, KYOTO (JP)

(21) Appl. No.: 16/332,048

(22) PCT Filed: Mar. 3, 2017
(86) PCT No.: PCT/JP2017/008584

§ 371 Date: Mar. 11, 2019

(30) Foreign Application Priority Data
Oct. 14, 2016 (JP) 2016-202565

(51) Int. Cl. G05D 1/00; B60W 40/08; B60W 50/00; B60K 28/06; B60W 50/14; B60W 30/182

(52) U.S. Cl. CPC G05D 1/0061; B60W 40/08; B60W 50/0098; B60W 2050/146; B60W 50/14; B60W 30/182; B60W 2040/0818; B60K 28/06

(57) ABSTRACT

When a driver camera is determined to operate abnormally during driving control performed in an automatic drive mode, determination is performed as to whether the driver is prepared for manual driving at the time point immediately before the driver camera is determined to operate abnormally. When the driver is determined prepared, a forced switching signal for forcibly switching from the automatic drive mode to the manual drive mode is output. When the driver is determined unprepared, determination is performed as to whether the driver recovers the state prepared for manual driving based on a detection signal output from a torque sensor while the automatic drive mode is retained. When the driver is determined to have recovered the state, the forced switching signal is output.

### FIELD

The present invention relates to a drive mode switch controller, a drive mode switch control method, and a drive mode control program for switching the drive mode of a vehicle between a manual drive mode and an automatic drive mode.

### BACKGROUND

In addition to a manual drive mode for driving a vehicle with a driving operation performed by a driver, an automatic drive mode has been developed for driving a vehicle along a predetermined route without a driver performing a driving operation. The automatic drive mode enables automatic driving of a vehicle by controlling, for example, a power unit, a steering unit, and a brake based on information generated by a navigation system using a global positioning system (GPS), traffic information obtained through road-to-vehicle communication, and information from a surrounding monitoring system that monitors the positions and movements of nearby pedestrians and vehicles (refer to, for example, Japanese Unexamined Patent Application Publication No. 2015-141053).

Although the automatic drive mode is expected to reduce the burden of the driving operation performed by the driver or to ease traffic congestion, automating the entire driving operation from the start to the end is unrealistic. Thus, the drive mode of a vehicle is to be switched appropriately from the automatic drive mode to the manual drive mode. Such switching from the automatic drive mode to the manual drive mode is preceded by determining whether the driver is prepared for manual driving.

However, a device for monitoring the state of the driver, such as a camera or a circuit for processing video signals from the camera, may become faulty or may malfunction to disable the determination of the driver state. In this case, the driver may be unable to take over the drive operation in a reliable manner. Thus, the drive mode cannot be switched from the automatic drive mode to the manual drive mode. However, retaining the automatic drive mode for a long period of time when the manual drive mode may become appropriate at any time can cause unsafe driving. Appropriate countermeasures are to be taken against any fault of the device for monitoring the state of the driver state.

One or more aspects of the present invention are directed to a drive mode switch controller, a drive mode switch control method, and a drive mode control program for appropriately controlling switching of the drive mode despite malfunctioning in monitoring the driver state.

### SUMMARY

In response to the above issue, a drive mode switch controller according to a first aspect of the present invention switches a drive mode of a vehicle between a manual drive mode and an automatic drive mode. The controller includes a first obtaining unit that obtains first sensing data indicating a state of a driver from a first monitoring sensor for monitoring the state of the driver and stores the first sensing data into a storage, a normality/abnormality determination unit that determines whether the first monitoring sensor operates normally or abnormally at time intervals, and a forced drive-mode switch signal output unit that forcibly switches the automatic drive mode to the manual drive mode during drive control performed in the automatic drive mode based on a result of the determination performed by the normality/abnormality determination unit and the first sensing data stored in the storage. The forced drive-mode switch signal output unit includes a first determination unit that determines, based on the first sensing data stored in the storage, whether the driver is prepared for performing a driving operation in the manual drive mode in a past predetermined period from when the first monitoring sensor is determined to operate abnormally, and a first switching signal output unit that outputs a signal for switching from the automatic drive mode to the manual drive mode when the driver is determined prepared for performing the driving operation in the manual drive mode.

The controller according to the first aspect of the present invention determines whether the driver is prepared for performing a driving operation in the manual drive mode in a past predetermined period from when the first monitoring sensor is determined to operate abnormally during the drive control performed in the automatic drive mode. When the driver is determined prepared for driving in the manual drive mode, the controller outputs a forced switching signal for forcibly switching the drive mode from the automatic drive mode to the manual drive mode. This structure prevents the automatic drive mode from being continued while, for example, the first monitoring sensor is faulty, and from disabling switching to the manual drive mode when the manual drive mode switching is actually appropriate.

A drive mode switch controller according to a second aspect of the present invention is the drive mode switch controller according to the first aspect further including a second obtaining unit that obtains second sensing data indicating the state of the driver from a second monitoring sensor for monitoring the state of the driver and is different from the first monitoring sensor. The forced drive-mode switch signal output unit includes a second determination unit that retains the automatic drive mode and determines whether the driver recovers a state prepared for performing the driving operation in the manual drive mode based on the second sensing data when the first determination unit determines that the driver is unprepared for performing the driving operation in the manual drive mode, and a second switching signal output unit that outputs a signal for switching from the automatic drive mode to the manual drive mode when the driver is determined to have recovered the state.

The controller according to the second aspect of the present invention retains the automatic drive mode and determines whether the driver recovers a state prepared for performing the driving operation in the manual drive mode based on the sensing data from the second monitoring sensor when the driver is determined unprepared for performing the driving operation in the manual drive mode in a past predetermined period from when the first monitoring sensor is determined to operate abnormally, and outputs a forced switching signal for forcibly switching to the manual drive mode when determining that the driver has recovered the state. This structure enables the drive mode to be switched to the manual drive promptly after the driver is determined to have recovered the state prepared for manual driving based on the sensing data from the second monitoring sensor, although the driver is determined unprepared for manual driving in a past predetermined period from when the first monitoring sensor is determined to operate abnormally.

A drive mode switch controller according to a third aspect of the present invention is the drive mode switch controller according to the second aspect in which the forced drive-mode switch signal output unit further including an operation end unit that determines whether the first monitoring sensor restores a state for operating normally while the second determination unit retains the automatic drive mode, and ends control performed by the second determination unit and control performed by the second switching signal output unit when determining that the first monitoring sensor has restored the state for operating normally.

The controller according to the third aspect of the present invention ends the control for outputting a forced switching signal for forcibly switching from the automatic drive mode to the manual drive mode when the operation of the first monitoring sensor or sensing data from the first monitoring sensor restores a normal state while the automatic drive mode is being retained and the driver is monitored for recovering a state prepared for manual driving. When, for example, sensing data from the first monitoring sensor is temporarily stopped, the automatic drive mode is retained without forcibly switching the drive mode to the manual drive mode. Thus, the driver can continuously benefit from automatic driving.

A drive mode switch controller according to a fourth aspect of the present invention is the drive mode switch controller according to any one of the first to third aspects in which the forced drive-mode switch signal output unit further including an informing unit that provides the driver with a message informing forced switching from the automatic drive mode to the manual drive mode.

The controller according to the fourth aspect of the present invention provides a message informing forced switching from the automatic drive mode to the manual drive mode to the driver when the first monitoring sensor is determined to operate abnormally. Thus, the driver can smoothly shift to the state prepared for manual driving. This enables smooth forced switching to the manual drive mode.

A drive mode switch controller according to a fifth aspect of the present invention is the drive mode switch controller according to any one of the first to fourth aspects further including a drive mode switching disabling controller that disables switching from the manual drive mode to the automatic drive mode when the normality/abnormality determination unit determines that the first monitoring sensor operates abnormally during drive control performed in the manual drive mode until a result of determination indicating normality is output by the normality/abnormality determination unit.

The controller according to the fifth aspect of the present invention disables switching from the manual drive mode to the automatic drive mode when the first monitoring sensor is determined to operate abnormally during the drive control performed in the manual drive mode until the determination result indicating normality is output again. This provides the advantageous effects described below.

After the drive mode is switched to the automatic drive mode while the first monitoring sensor remains faulty, switching to the manual drive mode can be disabled when such drive mode switching is actually appropriate, or the determination process for such switching may be complicated to disable smooth switching to the manual drive mode. This inconvenience in switching from the automatic drive mode to the manual drive mode can be avoided by disabling switching from the manual drive mode to the automatic drive mode until the operation of the first monitoring sensor is restored to normal operation.

The drive mode switch controller, method, and program according to the aspects of the present invention appropriately control switching of the drive mode despite malfunctioning in monitoring the driver state.

### BRIEF DESCRIPTION OF THE DRAWINGS

FIG. 1 is a schematic diagram of an automatic driving control system including a drive mode switch controller according to one embodiment of the present invention.

FIG. 2 is a functional block diagram of the drive mode switch controller according to the embodiment of the present invention.

FIG. 3 is a flowchart showing the procedure and the control for switching the drive mode performed by the drive mode switch controller shown in FIG. 2.

FIG. 4 is a flowchart showing the procedure and the control for switching the drive mode in the flowchart shown in FIG. 3.

FIG. 5 is a flowchart showing the procedure and the control for disabling drive mode switching in the flowchart shown in FIG. 3.

### DETAILED DESCRIPTION

### Embodiments

One or more embodiments of the present invention will now be described with reference to the drawings.

### Embodiment

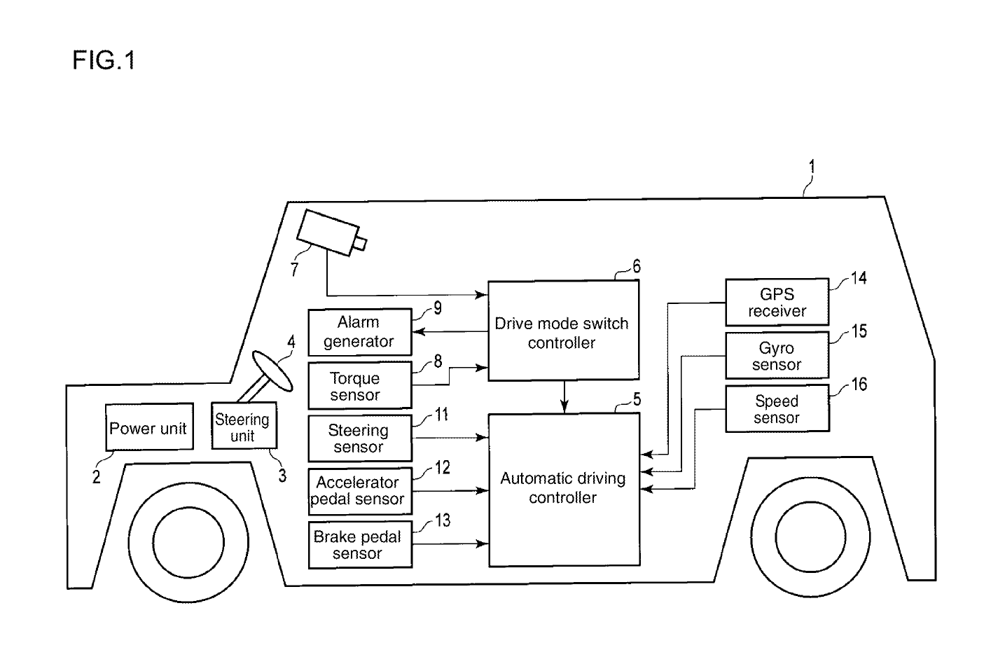

FIG. 1 is a schematic diagram of an automatic driving control system including a drive mode switch controller according to one embodiment of the present invention. The automatic driving control system is mounted on a vehicle 1, such as an automobile.

The vehicle 1 includes, as its basic components, a power unit 2 including a power supply and a transmission, and a steering unit 3 incorporating a steering wheel 4. The vehicle 1 has two drive modes, a manual drive mode and an automatic drive mode. The power supply includes an engine, a motor, or both.

The manual drive mode allows the vehicle 1 to travel mainly based on, for example, a manual driving operation performed by a driver. For example, the manual drive mode includes a vehicle driving operation mode for driving a vehicle with a driving operation performed by a driver alone, and an assisted driving mode for driving a vehicle mainly with a driving operation performed by a driver in combination with assisted driving.

For example, when the vehicle 1 travels along a curve, assisted driving assists the driver with the steering torque to achieve an appropriate steering quantity based on the curvature of the curve. Assisted driving further includes control for assisting the driver's acceleration (e.g., accelerator pedal operation) or the braking (e.g., brake pedal operation), manual steering (manual steering during driving), and manual speed regulation (manual speed control during driving). Manual steering refers to steering the vehicle 1 mainly with the driver's operation on the steering wheel 4. Manual speed regulation refers to adjusting the speed of the vehicle mainly with the driver's accelerating operation or braking operation.

Assisted driving excludes control for forcibly interrupting the driver's driving operation for automatically driving the vehicle. In other words, the manual drive mode reflects the driver's operation on the traveling vehicle within a predetermined allowable range, but excludes any control for forcibly interrupting the vehicle traveling under predetermined conditions (e.g., deviation of the vehicle from a lane).

In contrast, the automatic drive mode enables automatic driving of a vehicle along a road on which the vehicle is traveling. The automatic drive mode includes automatic driving of a vehicle to a predetermined destination without the driver performing a driving operation. The automatic drive mode is not limited to complete automatic control of the vehicle, and includes driving that reflects the driver's operation in the traveling vehicle within a predetermined allowable range. In other words, the automatic drive mode includes control for forcibly interrupting the vehicle travelling under predetermined conditions while reflecting the driver's operation on the traveling vehicle within a predetermined allowable range.

An automatic driving controller 5 controls driving in the automatic drive mode, and obtains sensing data from a steering sensor 11, an accelerator pedal sensor 12, a brake pedal sensor 13, a global positioning system (GPS) receiver 14, a gyro sensor 15, and a speed sensor 16. The automatic driving controller 5 automatically controls the travelling of the vehicle 1 based on the sensing data, route information generated by a navigation system (not shown), traffic information obtained through road-to-vehicle communication, and information obtained by a surrounding monitoring system that monitors the positions and movements of nearby pedestrians and vehicles.

The automatic control includes autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane when, for example, the driver is not performing a steering operation. During the operation of LKA, the steering operation of the driver may be reflected in the vehicle steering within the range in which the vehicle 1 stays in the driving lane (allowable range). Autosteering is not limited to LKA.

Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle. During the operation of ACC, the automatic driving controller 5 decelerates the vehicle 1 in response to the driver's braking (e.g., brake pedal operation), or accelerates the vehicle in response to the driver's acceleration (e.g., accelerator pedal operation) up to a predetermined maximum permissible speed (e.g., the legally defined maximum speed on the road being traveled). Automatic speed regulation is not limited to ACC, but may include cruise control (CC) that performs constant speed control alone.

An automatic driving control system according to one embodiment includes a drive mode switch controller 6, which switches between the manual drive mode and the automatic drive mode, a driver camera 7, which serves as a first monitoring sensor, a torque sensor 8, which serves as a second monitoring sensor, and an alarm generator 9.

The driver camera 7 is installed in front of a driver, such as on the dashboard, to capture images of the driver. The driver camera 7 outputs the video signals representing the captured images to the drive mode switch controller 6. The torque sensor 8 detects a torque generated when the driver operates the steering wheel 4, and outputs the detection signal to the drive mode switch controller 6. The alarm generator 9 includes a speaker and a display to output the sound signals carrying messages output from the drive mode switch controller 6 through the speaker, and display the display signals carrying the messages on the display.

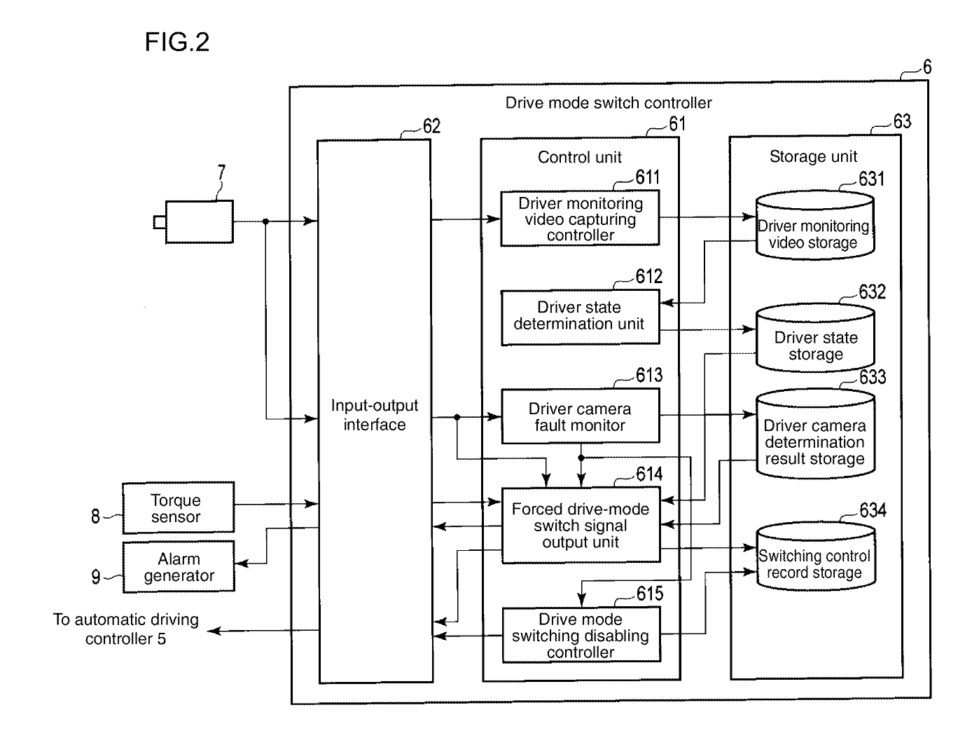

The drive mode switch controller 6, which centrally controls switching of the drive mode, has the structure described below. FIG. 2 is a functional block diagram of the drive mode switch controller 6.

More specifically, the drive mode switch controller 6 includes a control unit 61, an input-output interface 62, and a storage unit 63.

The input-output interface 62 receives video signals output from the driver camera 7 and torque detection signals output from the torque sensor 8, and converts the signals into digital data. The input-output interface 62 also converts messages output from the control unit 61 into sound signals and display signals, and outputs the signals to the alarm generator 9. The input-output interface 62 also outputs drive mode switching control signals output from the control unit 61 to the automatic driving controller 5.

The storage unit 63 includes, as storage media, a nonvolatile memory, such as a solid state drive (SSD) or a hard disk drive (HDD), which is writable and readable as appropriate, and a volatile memory, such as a random access memory (RAM). The storage unit 63 includes, as a storage area for implementing one embodiment, a driver monitoring video storage 631, a driver state storage 632, a driver camera determination result storage 633, and a switching control record storage 634.

The control unit 61 includes a central processing unit (CPU) and a program memory, which form a computer. The control unit 61 includes, as its control functions for implementing one embodiment, a driver monitoring video capturing controller 611, a driver state determination unit 612, a driver camera fault monitor 613, which serves as a normality/abnormality determination unit, a forced drive-mode switch signal output unit 614, and a drive mode switching disabling controller 615. These control functions are implemented by the CPU executing programs stored in the program memory.

The driver monitoring video capturing controller 611 receives, through the input-output interface 62, digital data (driver monitoring video data) for the driver video signal output from the driver camera 7, and stores the received driver monitoring video data into the driver monitoring video storage 631 included in the storage unit 63.

The driver state determination unit 612 reads the driver monitoring video data at predetermined time intervals from the driver monitoring video storage 631. Every after reading the driver monitoring video data, the driver state determination unit 612 determines whether the driver is prepared for manual driving based on the driver monitoring video data. For example, the driver state determination unit 612 determines whether the driver has his or her eyes closed, or specifically whether the driver is asleep. The driver state determination unit 612 then stores information indicating the determination result into the driver state storage 632, in a manner associated with a time stamp indicating the time point of determination.

The driver camera fault monitor 613 determines whether the driver camera 7 operates normally or abnormally based on the video signal output from the driver camera 7. Determining whether the driver camera 7 operates normally or abnormally includes detecting an abnormality in each video signal output from the driver camera 7, in addition to detecting any fault of the driver camera 7. The determination as to whether the driver camera 7 operates normally or abnormally is performed in synchronization with when the driver state is determined by the driver state determination unit 612. The driver camera fault monitor 613 transmits the normality/abnormality determination result to the forced drive-mode switch signal output unit 614 and the drive mode switching disabling controller 615, and also stores the result into the driver camera determination result storage 633 in a manner associated with a time stamp indicating the corresponding time point of determination.

When receiving a determination result indicating that the driver camera 7 operates abnormally from the driver camera fault monitor 613 during the driving control in the automatic drive mode, the forced drive-mode switch signal output unit 614 performs control for outputting a forced drive mode switch signal for forcibly switching the drive mode from the automatic drive mode to the manual drive mode. The forced switch signal output control includes the processes described below.

1. Generating a message informing forced switching from the automatic drive mode to the manual drive mode, and outputting the message to the alarm generator 9.

2. Reading, from the driver state storage 632, the driver state determination result obtained by the driver state determination unit 612 at the time point of determination immediately before the driver camera 7 is determined to operate abnormally, and determining whether the driver is prepared for manual driving based on the read driver state determination result.

3. Outputting, when the driver is determined prepared for manual driving, a forced switching signal for forcibly switching from the automatic drive mode to the manual drive mode to the automatic driving controller 5.

4. Determining, when the driver is determined unprepared for manual driving, whether the driver recovers a state prepared for manual driving based on the detection signal output from the torque sensor 8 after retaining the automatic drive mode.

When, for example, a torque with a predetermined value or higher is detected, the driver is determined to have recovered the state prepared for manual driving. When the driver is determined to have recovered the state, a forced switching signal for forcibly switching from the automatic drive mode to the manual drive mode is output to the automatic driving controller 5.

5. Ending the control for outputting a forced drive-mode switch signal when the driver camera 7 monitored in the process 4 is restored to normal operation.

6. Storing information indicating the results from the processes 1 to 5 in the switching control record storage 634 as information indicating the record of the forced switching control.

When receiving a determination result indicating that the driver camera 7 operates abnormally from the driver camera fault monitor 613 during the driving control in the manual drive mode, the drive mode switching disabling controller 615 disables switching from the manual drive mode to the automatic drive mode. This switch disabling includes the processes described below.

1. Generating a message indicating that switching to the automatic drive mode is disabled, and outputting the message to the alarm generator 9.

2. Determining, when a request for switching to the automatic drive mode is received, whether the driver camera 7 is restored to normal operation, and outputting the switching signal for switching to the automatic drive mode to the automatic driving controller 5 when the determination result indicates that the driver camera 7 is restored or retaining the manual drive mode when the result indicates that the driver camera 7 has not been restored.

The alarm generator 9 and the drive mode switching disabling controller 615 may be selectively combined or may be eliminated.

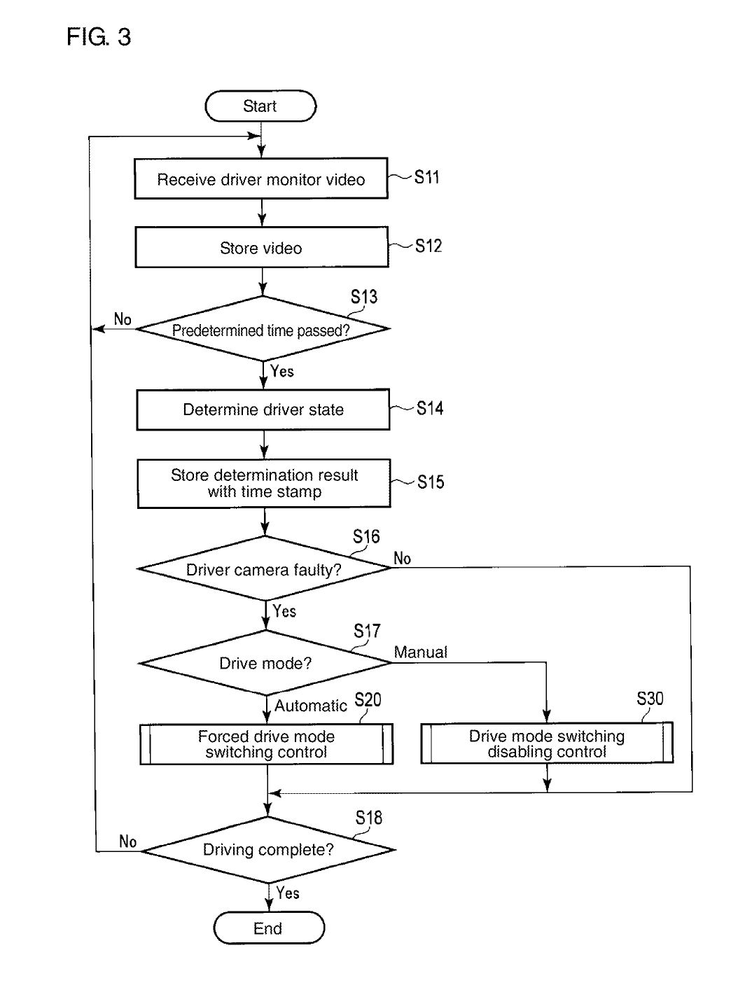

The operation of the drive mode switch controller with the above structure will now be described. FIG. 3 is a flowchart showing the overall procedure and control.

### 1. Obtaining Driver Monitoring Video

When the vehicle starts driving, the driver camera 7 is activated to continuously capture images of a specific area including the driver's face and output the video signals representing the captured images. In this state, the drive mode switch controller 6 controlled by the driver monitoring video capturing controller 611 receives digital data (driver monitoring video data) representing the video signals output from the driver camera 7 in step S11 through the input-output interface 62, and stores the received driver monitoring video data into the driver monitoring video storage 631 included in the storage unit 63 in step S12.

The images of the driver may be captured intermittently at intervals shorter than the time intervals at which the driver state is determined, as described later. The driver camera 7 or the input-output interface 62 may encode the video signals with a predetermined encoding scheme. This reduces the amount of monitoring video data, thus saving the storage capacity of the driver monitoring video storage 631.

### 2. Determining Driver State

After the driver monitoring video data starts being obtained, the drive mode switch controller 6 reads, upon every predetermined time determined in step S13, the driver monitoring video data from the driver monitoring video storage 631 in step S14 as controlled by the driver state determination unit 612. The drive mode switch controller 6 then determines whether the driver is prepared for manual driving based on every read set of driver monitoring video data.

For example, the drive mode switch controller 6 determines the degree of eye opening, the frequency of blinking, or the eye movement of the driver based on the driver monitoring video data to calculate the degree of awakening of the driver. The drive mode switch controller 6 then determines whether the driver is prepared for manual driving by comparing the degree of awakening with a threshold. The degree of awakening may be expressed in percent (%) to the completely awake state.

After the determination result indicating whether the driver is prepared for manual driving is obtained, the driver state determination unit 612 stores information about the determination result into the driver state storage 632 in a manner associated with information about the time point of determination, such as time stamp information, in step S15.

### 3. Monitoring for any Fault of Driver Camera 7

The drive mode switch controller 6 controlled by the driver camera fault monitor 613 then determines whether the driver camera 7 operates normally or abnormally, or whether the driver camera 7 is faulty in step S16 at the same time as when the driver camera fault monitor 613 determines the driver state. The driver state determination may be performed at the time different from when the determination for any fault of driver camera 7 is performed.

The determination as to whether the driver camera 7 operates normally or abnormally is based on, for example, the determination as to whether the driver camera 7 outputs video signals or whether the luminance value of the output video signal is saturated. The determination as to whether the driver camera 7 with self-diagnosis functionality operates normally or abnormally may be based on a self-diagnosis signal output from the driver camera 7.

Information indicating the normality/abnormality determination result from the driver camera 7 is stored in the driver camera determination result storage 633 in a manner associated with information about the time point of determination, such as time stamp information. The information indicating the determination result is used to accurately specify the time point immediately before the driver camera 7 becomes faulty in the past record.

### 4. Forced Drive-Mode Switch Signal Output Control

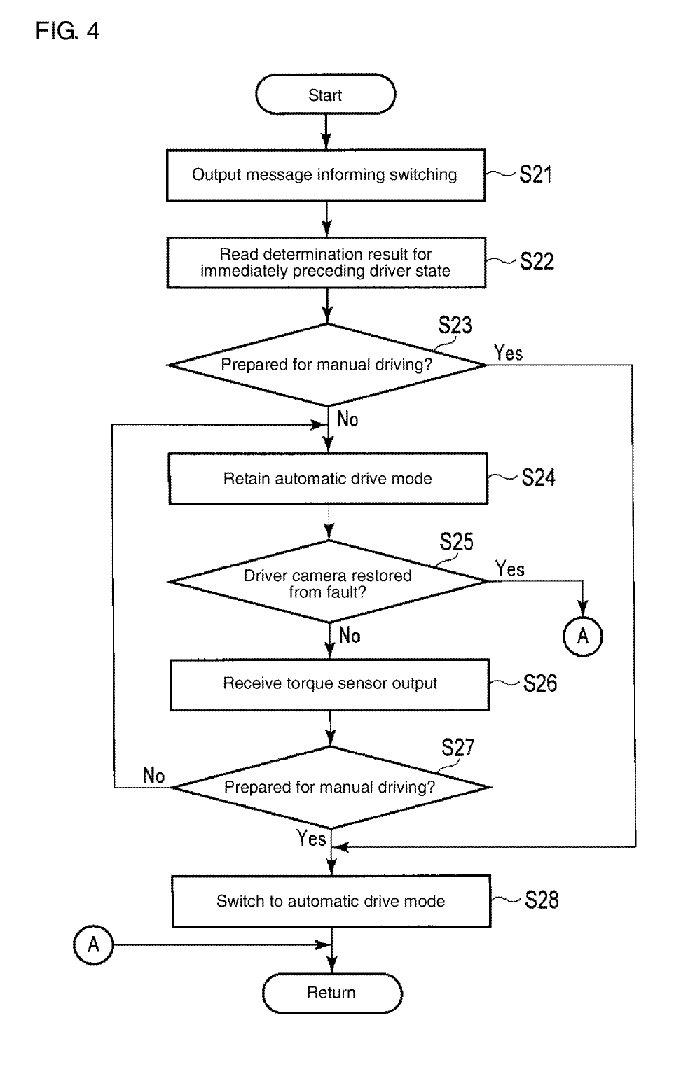

After receiving information indicating that the driver camera 7 operates abnormally from the driver camera fault monitor 613, the drive mode switch controller 6 determines whether the drive mode currently set in step S17 is the automatic drive mode or the manual drive mode. When the drive mode switch controller 6 determines that the current drive mode is the automatic drive mode, the drive mode switch controller 6 performs forced switch signal output control for forcibly switching the drive mode in step S20, as controlled by the forced drive-mode switch signal output unit 614. FIG. 4 is a flowchart showing the procedure and the control.

More specifically, the forced drive-mode switch signal output unit 614 first generates and outputs a message informing forced switching from the automatic drive mode to the manual drive mode in step S21. This switch-informing message is converted into a sound signal and a display signal by the input-output interface 62, which are then output to the alarm generator 9.

The alarm generator 9 outputs the sound signal from the speaker as a voice message, and displays the display signal on the display as a visible message. These messages inform the driver that the drive mode is being forcibly switched to the manual drive mode to allow the driver to prepare for the manual drive mode.

The switch-informing messages may be provided in another manner, by, for example vibrating a vibrator attached to a driver's seat.

In step S22, the forced drive-mode switch signal output unit 614 reads the determination result indicating the driver state immediately before the driver camera 7 becomes faulty from the driver state storage 632. The forced drive-mode switch signal output unit 614 can accurately specify the time point immediately before the driver camera 7 becomes faulty by referring to the normality/abnormality determination result from the driver camera 7 within a past predetermined period stored in the driver camera determination result storage 633.

In step S23, the forced drive-mode switch signal output unit 614 determines whether the driver is prepared for manual driving based on the read determination result indicating the driver state immediately before the driver camera 7 becomes faulty. When the determination result indicates that the driver is prepared for manual driving, the processing advances to step S28. The message informing switching of the drive mode from the automatic drive mode to the manual drive mode is generated and output to the alarm generator 9, and then a signal for forcibly switching to the manual drive mode is generated and output. The forced switching signal is then provided to the automatic driving controller 5 through the input-output interface 62. The automatic driving controller 5 ends the automatic drive mode, after which driving is controlled in accordance with the manual operation performed by the driver.

When the driver is determined unprepared for manual driving in step S23, the forced drive-mode switch signal output unit 614 retains the automatic drive mode in step S24, and then determines whether the driver camera 7 has been restored from the fault in step S25. This determination is based on the latest determination result obtained by the driver camera fault monitor 613.

When the results are consecutively determined to indicate normality at predetermined time points of determination, the driver camera 7 may be determined to have been restored from the fault. This enables more accurate determination of the restored state of the driver camera 7.

When the driver camera 7 is determined to have been restored in step S25, the forced drive-mode switch signal output unit 614 ends the forced drive mode switching control to return to normal drive mode switching control.

When the driver is determined unprepared for manual driving in step S23, the processing in step S24 may be performed after the steps S25 and S26.

When the driver camera 7 is determined not to have been restored in step S25, the forced drive-mode switch signal output unit 614 receives a detection signal indicating the steering torque output from the torque sensor 8 through the input-output interface 62 in step S26. In step S27, the forced drive-mode switch signal output unit 614 determines whether the driver is prepared for manual driving based on the received detection signal indicating the steering torque.

When, for example, a torque with a predetermined value or higher is detected, the forced drive-mode switch signal output unit 614 determines that the driver recovers a state prepared for manual driving. When the driver is determined unprepared for manual driving, the forced drive-mode switch signal output unit 614 returns to step S24 to repeat the processing in steps S25 to S27 while retaining the automatic drive mode. The message informing switching to the manual drive mode may be output every time the processing in steps S25 to S27 is repeated.

The driver is prepared for the manual drive mode, and grips the steering wheel 4. In step S27, the driver is determined prepared for manual driving based on the detection signal indicating the steering torque. The forced drive-mode switch signal output unit 614 advances to step S28, generates a message informing switching of the drive mode from the automatic drive mode to the manual drive mode, outputs the message to the alarm generator 9, and then outputs a signal for forcibly switching to the manual drive mode. The automatic driving controller 5 thus ends the automatic drive mode, and subsequently controls driving in accordance with the manual operation performed by the driver.

In the manner described above, the drive mode is forcibly switched from the automatic drive mode to the manual drive mode. The performance result of the forced switch signal output control in the above drive mode is stored in the switching control record storage 634 as information indicating the switching control record together with information indicating the corresponding time point of switching. Information indicating the switching control record is used later as, for example, information for tracking the operational state of a system including the faulty driver camera 7.

### 5. Drive Mode Switch Disabling Control

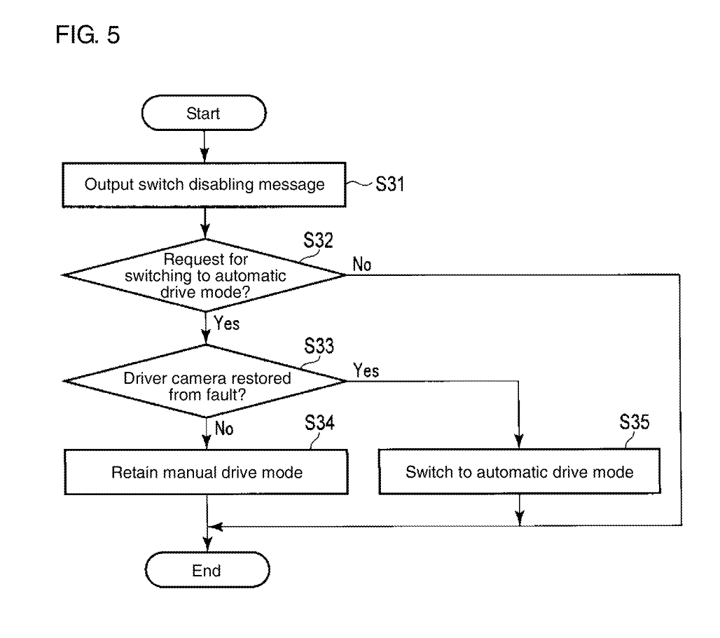

When receiving information indicating that the driver camera 7 operates abnormally from the driver camera fault monitor 613, and the drive mode currently set in step S17 is determined to be the manual drive mode, the drive mode switch controller 6 disables switching of the drive mode in step S30 (described later) as controlled by the drive mode switching disabling controller 615. FIG. 5 is a flowchart showing the procedure and the control.

More specifically, the drive mode switching disabling controller 615 generates and outputs a message informing that switching from the manual drive mode to the automatic drive mode is disabled in step S31. This switch-informing message is converted into a sound signal and a display signal by the input-output interface 62, which are then output to the alarm generator 9.

The alarm generator 9 outputs the sound signal from the speaker as a voice message, and displays the display signal on the display as a visible message. These messages inform the driver that switching to the automatic drive mode is disabled.

The driver who misses the switch disabling message for some reason may input a request for switching to the automatic drive mode, or the vehicle 1 may enter a road section that allows the drive control performed in the automatic drive mode and receive a request for switching to the automatic drive mode.

In this case, when detecting an input or generation of the switch request in step S32, the drive mode switching disabling controller 615 determines whether the driver camera 7 has been restored from the fault in step S33. The determination is based on the latest determination result obtained by the driver camera fault monitor 613. In this case as well, when the results are consecutively determined to indicate normality at predetermined time points of determination, the driver camera 7 may be determined to have been restored from the fault. This enables more accurate determination of the restored state of the driver camera 7.

When the driver camera 7 is determined not to have been restored in step S33, the drive mode switching disabling controller 615 advances to step S34 to retain the manual drive mode. The drive mode switching disabling controller 615 generates a message indicating that the manual drive mode is retained and outputs the message to the alarm generator 9.

The driver camera 7 is determined to have been restored in step S33. The drive mode switching disabling controller 615 advances to step S35, generates a message informing switching to the automatic drive mode, and outputs the message to the alarm generator 9. The drive mode switching disabling controller 615 then generates and outputs a forced switching signal for switching the drive mode from the manual drive mode to the automatic drive mode. The forced switching signal is provided to the automatic driving controller 5 through the input-output interface 62. Thus, the automatic driving controller 5 switches the drive mode to the automatic drive mode, and then starts automatic drive control.

In the manner described above, switching from the manual drive mode to the automatic drive mode is disabled when the driver camera 7 becomes faulty. In this case as well, the results of the drive mode switch disabling control are stored in the switching control record storage 634 as information indicating the switching control record together with information indicating the corresponding time points of switching. The information indicating the switching control record is used later as, for example, information for tracking the operational state of a system including the faulty driver camera 7.

### 6. Ending Drive Mode Switching Control

When the forced switch signal output control of the drive mode in step S20 or the drive mode switch disabling process in step S30 is complete, the drive mode switch controller 6 determines whether the driving is complete in step S18. When the drive control is continuous, the processing returns to step S11 to repeat the control procedure described above. When the driving is determined complete, the drive mode switching control ends.

The determination as to whether the driving is complete in step S18 is similarly performed when no fault of the driver camera 7 is detected in step S16.

As described in detail above, when the driver camera 7 is determined to operate abnormally during the driving control in the automatic drive mode in one embodiment of the present invention, the forced drive-mode switch signal output unit 614 first determines whether the driver is prepared for manual driving at the time point immediately before the driver camera 7 is determined to operate abnormally. When the driver is determined prepared for manual driving, the forced drive-mode switch signal output unit 614 outputs a forced switching signal for forcibly switching from the automatic drive mode to the manual drive mode. This structure prevents the automatic drive mode from being continued due to the faulty driver camera 7 and from disabling switching of the drive mode to the manual drive mode when such drive mode switching is actually appropriate, like when the vehicle approaches the end point of an automatic drive cruise section.

When the driver is determined unprepared for manual driving, the automatic drive mode is retained and the determination as to whether the driver recovers the state prepared for manual driving is performed based on the detection signal from the torque sensor 8. The forced switching signal is then output in response to the driver state recovered for manual driving. This structure enables, when the driver is unprepared for manual driving, switching of the drive mode to the manual drive readily after the driver is determined to have recovered the state prepared for manual driving based on the detection signal from the torque sensor 8.

The driver camera 7 may be restored to the normal operation while the automatic drive mode is being retained and the driver recovering the state prepared for manual driving is being monitored. This ends the control for outputting a signal for forcibly switching to the manual drive mode output control from the automatic drive mode. When, for example, a monitoring video signal from the driver camera 7 is temporarily stopped or the luminance value is temporarily saturated, the automatic drive mode can be retained without outputting the signal for forcibly switching to the manual drive mode. Thus, the driver can continuously benefit from automatic driving.

When the driver camera 7 is determined to operate abnormally, a message informing forced switching from the automatic drive mode to the manual drive mode is provided to the driver. The driver can thus smoothly shift to manual driving, thus enabling smooth forced switching to the manual drive mode.

When the driver camera 7 is determined to operate abnormally during the drive control performed in the manual drive mode, switching from the manual drive mode to the automatic drive mode is disabled until the driver camera 7 is restored to normal operation. This procedure has the advantageous effects described below. After the drive mode is switched to the automatic drive mode, any fault in the driver camera 7 can disable switching to the manual drive mode when such drive mode switching is actually appropriate, or may complicate the determination process for such switching and disable smooth switching to the manual drive mode. This inconvenience can be avoided in the above embodiment by disabling switching from the manual drive mode to the automatic drive mode until the driver camera 7 is restored to normal operation.

### Other Embodiments

In the above embodiment, a video signal representing an image including the driver's face obtained by the driver camera 7 is used by a first unit for determining the driver state. In some embodiments, the driver state may be determined based on vital sign signals for the driver obtained by a vital sign sensor, such as pulse wave signals detected by a pulse wave sensor, heartbeat signals detected by a heartbeat sensor, or signals indicating the driver's diaphragm moving up and down detected by a pressure sensor.

In the above embodiment, a steering torque in the steering operation of the driver detected by the torque sensor 8 is used by a second unit for determining the driver state. In some embodiments, the driver state may be determined by an operation input unit for receiving an input from the driver indicating that the driver recovers the state prepared for manual driving, such as a push button on the steering wheel 4 or a software button on a touch screen, or may be determined in response to an operation on the accelerator pedal.

In the above embodiment, the driver state is determined at constant time intervals, and the determination result is stored into the driver state storage 632 in a manner associated with information about the time point of determination. During the control for outputting the forced drive mode switch signal, in some embodiments, the driver monitoring video data corresponding to the time point of determination immediately before the driver camera 7 becomes faulty may be read from the driver monitoring video storage 631, and the driver state may be determined based on the driver monitoring video data.

Other details including the type of vehicle, the functions of the automatic driving controller, and the functions, procedure, and control of the drive mode switch controller may be modified variously without departing from the spirit and scope of the present invention.

The present invention is not limited to the embodiments described above, but may be variously modified without departing from the spirit and scope of the invention. The above embodiments may be combined in any possible manner to achieve effects produced by such combinations. The above embodiments include various stages of the invention, and the components described herein may further be selected or combined to provide various aspects of the invention.

The above embodiments may be partially or entirely expressed in, but not limited to, the following forms shown in the appendixes below.

### APPENDIX 1

A drive mode switch controller for switching a drive mode of a vehicle between a manual drive mode and an automatic drive mode, the controller comprising:

a memory including a storage for storing first sensing data indicating a state of a driver, and

at least one hardware processor connected to the memory, the at least one hardware processor being configured to

obtain the first sensing data indicating the state of the driver from a first monitoring sensor and store the first sensing data into the storage;

determine whether the first monitoring sensor operates normally or abnormally at time intervals; and

determine, based on the first sensing data stored in the storage, whether the driver is prepared for performing a driving operation in the manual drive mode in a past predetermined period from when the first monitoring sensor is determined to operate abnormally, and

switch the automatic drive mode to the manual drive mode when the driver is determined prepared for performing the driving operation in the manual drive mode.

### APPENDIX 2

A drive mode switch control method implemented by a controller for switching a drive mode of a vehicle between a manual drive mode and an automatic drive mode, the method comprising:

obtaining, with at least one hardware processor, first sensing data indicating a state of a driver from a first monitoring sensor for monitoring the state of the driver and storing the first sensing data into at least one memory;

determining, with the at least one hardware processor, whether the first monitoring sensor operates normally or abnormally at time intervals; and

forcibly switching, with the at least one hardware processor, the automatic drive mode to the manual drive mode based on a result of determination in the normality/abnormality determination and the first sensing data stored in the storage during drive control performed in the automatic drive mode,

wherein forcibly switching the automatic drive mode to the manual drive mode includes
determining, with the at least one hardware processor, based on the first sensing data stored in the storage, whether the driver is prepared for performing a driving operation in the manual drive mode in a past predetermined period from when the first monitoring sensor is determined to operate abnormally in the normality/abnormality determination, and
outputting, with the at least one hardware processor, a signal for switching from the automatic drive mode to the manual drive mode when the driver is determined prepared for performing the driving operation in the manual drive mode in the determination based on the first sensing data.

1. A drive mode switch controller for switching a drive mode of a vehicle between a manual drive mode and an automatic drive mode, the controller comprising:
a processor configured with a program to perform operations comprising:
operation as a first obtaining unit configured to obtain first sensing data indicating a state of a driver from a first monitoring sensor for monitoring the state of the driver and store the first sensing data into a storage;
operation as a normality/abnormality determination unit configured to determine whether the first monitoring sensor operates normally or abnormally at time intervals; and
operation as a forced drive-mode switch signal output unit configured to output a signal for forcibly switching from the automatic drive mode to the manual drive mode during drive control performed in the automatic drive mode based on a result of the determination performed by the normality/abnormality determination unit and the first sensing data stored in the storage, wherein
the processor is configured with the program such that operation as the forced drive mode switch signal output unit comprises operation as the forced drive-mode switch signal output unit that performs operations further comprising:
operation as a first determination unit configured to determine, based on the first sensing data stored in the storage, whether the driver is prepared for performing a driving operation in the manual drive mode in a past predetermined period in which the normality/abnormality determination unit determines that the first monitoring sensor operates abnormally, and
operation as a first switching signal output unit configured to output a signal for switching from the automatic drive mode to the manual drive mode in response to the first determination unit determining that the driver is prepared for performing the driving operation in the manual drive mode.

2. The drive mode switch controller according to claim 1, wherein
the processor is configured with the program to perform operations further comprising operation as a second obtaining unit configured to obtain second sensing data indicating the state of the driver from a second monitoring sensor for monitoring the state of the driver, the second monitoring sensor being different from the first monitoring sensor; and
the processor is configured with the program such that operation as the forced drive mode switch signal output unit comprises operation as the forced drive-mode switch signal output unit that performs operations further comprising:
operation as a second determination unit configured to retain the automatic drive mode and determine whether the driver recovers a state prepared for performing the driving operation in the manual drive mode based on the second sensing data in response to the first determination unit determining that the driver is unprepared for performing the driving operation in the manual drive mode, and
operation as a second switching signal output unit configured to output a signal for switching from the automatic drive mode to the manual drive mode in response to the second determination unit determining that the driver has recovered the state prepared for performing the driving operation in the manual drive mode.

3. The drive mode switch controller according to claim 2, wherein the processor is configured with the program such that operation as the forced drive-mode switch signal output unit comprises operation as the forced drive-mode switch signal output unit that performs operations further comprising:
operation as an operation end unit configured to determine whether the first monitoring sensor restores a state for operating normally while the second determination unit retains the automatic drive mode, and to end an operation performed by the second determination unit and an operation performed by the second switching signal output unit in response to determining that the first monitoring sensor has restored the state for operating normally.

4. The drive mode switch controller according to claim 1, wherein the processor is configured with the program such that operation as the forced drive-mode switch signal output unit comprises operation as the forced drive-mode switch signal output unit that performs operations further comprising operation as an informing unit configured to provide the driver with a message informing forced switching from the automatic drive mode to the manual drive mode.

5. The drive mode switch controller according to claim 1, wherein the processor is configured with the program to perform operations further comprising:
operation as a drive mode switching disabling controller configured to disable switching from the manual drive mode to the automatic drive mode in response to the normality/abnormality determination unit determining that the first monitoring sensor operates abnormally during drive control performed in the manual drive mode until a result of determination indicating normality is output by the normality/abnormality determination unit.

6. A drive mode switch control method implemented by a controller for switching a drive mode of a vehicle between a manual drive mode and an automatic drive mode, the method comprising:
obtaining, with the controller, first sensing data indicating a state of a driver from a first monitoring sensor for monitoring the state of the driver and storing the first sensing data into a storage;
determining, with the controller, whether the first monitoring sensor operates normally or abnormally at time intervals; and
outputting, with the controller, a signal for forcibly switching from the automatic drive mode to the manual drive mode in response to the first monitoring sensor being determined to operate abnormally in the normality/abnormality determination during drive control performed in the automatic drive mode, wherein
outputting the signal for forcibly switching comprises:
determining, based on the first sensing data stored in the storage, whether the driver is prepared for performing a driving operation in the manual drive mode in a past predetermined period from in response to the first monitoring sensor being determined to operate abnormally, and
outputting a signal for switching from the automatic drive mode to the manual drive mode in response to the driver being determined to be prepared for performing the driving operation in the manual drive mode in the determination based on the first sensing data.

7. The drive mode switch control method according to claim 6, further comprising:
obtaining second sensing data indicating the state of the driver from a second monitoring sensor for monitoring the state of the driver, the second monitoring sensor being different from the first monitoring sensor, wherein
outputting the signal for forcibly switching further comprises:
retaining the automatic drive mode and determining whether the driver recovers a state prepared for performing the driving operation in the manual drive mode based on the second sensing data in response to the driver being determined to be unprepared for performing the driving operation in the manual drive mode in the determination based on the first sensing data; and
outputting a signal for switching from the automatic drive mode to the manual drive mode in response to the driver being determined to have recovered the state prepared for performing the driving operation in the manual drive mode in the determination based on the second sensing data.

8. A non-transitory computer-readable storage medium storing a program, which when read and executed, causes a computer to perform operations comprising operation as the drive mode switch controller according to claim 1.

9. The drive mode switch controller according to claim 2, wherein the processor is configured with the program such that operation as the forced drive-mode switch signal output unit comprises operation as the forced drive-mode switch signal output unit that performs operations further comprising:
operation as an informing unit configured to provide the driver with a message informing forced switching from the automatic drive mode to the manual drive mode.

10. The drive mode switch controller according to claim 2, wherein the processor is configured with the program to perform operations further comprising:
operation as a drive mode switching disabling controller configured to disable switching from the manual drive mode to the automatic drive mode in response to the normality/abnormality determination unit determining that the first monitoring sensor operates abnormally during drive control performed in the manual drive mode until a result of determination indicating normality is output by the normality/abnormality determination unit.

11. The drive mode switch controller according to claim 3, wherein the processor is configured with the program such that operation as the forced drive-mode switch signal output unit comprises operation as the forced drive-mode switch signal output unit that performs operations further comprising:
operation as an informing unit configured to provide the driver with a message informing forced switching from the automatic drive mode to the manual drive mode.

12. The drive mode switch controller according to claim 3, further comprising:
a drive mode switching disabling controller configured to disable switching from the manual drive mode to the automatic drive mode in response to the normality/abnormality determination unit determining that the first monitoring sensor operates abnormally during drive control performed in the manual drive mode until a result of determination indicating normality is output by the normality/abnormality determination unit.

13. The drive mode switch controller according to claim 4, further comprising:
a drive mode switching disabling controller configured to disable switching from the manual drive mode to the automatic drive mode in response to the normality/abnormality determination unit determining that the first monitoring sensor operates abnormally during drive control performed in the manual drive mode until a result of determination indicating normality is output by the normality/abnormality determination unit.

14. A non-transitory computer-readable storage medium storing a program, which when read and executed, causes a computer to perform operations comprising operation of the drive mode switch controller according to claim 2.

15. A non-transitory computer-readable storage medium storing a program, which when read and executed, causes a computer to perform operations comprising operation of the drive mode switch controller according to claim 3.

16. A non-transitory computer-readable storage medium storing a program, which when read and executed, causes a computer to perform operations comprising operation of the drive mode switch controller according to claim 4.

17. A non-transitory computer-readable storage medium storing a program, which when read and executed, causes a computer to perform operations comprising operation of the drive mode switch controller according to claim 5.
